(19) United States
(12) Patent Application Publication
(10) Pub. No.: US 2015/0216288 A1
(43) Pub. Date: Aug. 6, 2015

(54) MULTIPURPOSE DEVICE

(71) Applicant: Johanna OFFNER, Wien (AT)

(72) Inventor: Johanna Offner, Wien (AT)

(21) Appl. No.: 14/425,097

(22) PCT Filed: Aug. 28, 2013
(86) PCT No.: PCT/EP2013/067760

§ 371 Date: Mar. 2, 2015

(30) Foreign Application Priority Data
Aug. 30, 2012 (AT) A 951/2012

(51) Int. Cl. A45D 44/22; G02C 11/06; G02C 11/00

(52) U.S. Cl. CPC A45D 44/22; G02C 11/00; G02C 11/06

(57) ABSTRACT

A multipurpose device includes one or more supporting parts which can contact a user's head and preferably a vision aid and/or a hearing aid. At least one supporting part has a tensioning device for tautening the user's facial skin. The tightening device is or can be connected to the supporting part and is pivotable about an axis of rotation. The tensioning device has a tensioning bow and a spring element tensioning the tensioning bow. The tensioning bow is disposed on the side of the supporting part facing the user's head and the spring element is engaged at one end with the supporting part and at the other with the tensioning bow.

The invention relates to a multipurpose device comprising one or a plurality of supporting parts, which can be applied to the head of a user and preferably comprising a vision aid and/or a hearing aid, wherein at least one supporting part encompasses a tensioning device for tightening the facial skin of the user, wherein the tensioning device is connected or can be connected to the supporting part and is pivotable about an axis of rotation.

To tension loose facial muscles permanently, it is common to perform maxillofacial surgeries. These surgical procedures are associated with high costs, whereby undesired side effects and long-term consequences can also not be avoided. Due to the fact that older persons oftentimes wish to look younger only for a short period of time for public events, the known disadvantages can be avoided by means of the present invention.

Eyeglass frames in any thickness belong to the known state of the art. In particular for the lateral posts between the vision aid and the ear bow, very wide bars have already become common. Eyeglass frames are known comprising a plurality of links, comprising connection assembles or hinges between the links, as well as comprising elastic links.

For example, DE 20 2006 011493 U1 describes eyeglasses for fighting wrinkles, in the case of which pads are attached to the temples of the eyeglasses, which rest against the temple or the corner of the eye, respectively, of the user when the eyeglasses are put on, and which tautens the facial skin in this area.

To attain a tautening of the facial skin, pressure must be generated on the facial muscles and rearwards tension must be generated. This is attained by means of temples, which can be telescoped. A spring, which is connected to the pads, is located in the interior of the temples. When putting on the eyeglasses, the spring is tensioned and the pads have the effect that the facial skin is tautened backwards by pulling slightly.

Devices for smoothing the facial skin or the laugh lines, respectively, at the corners of the mouth, which are highly effective from the back of the head or the neck, have become known as further state of the art. These known devices have the disadvantage of a relatively complicated design, because the entire temple must be designed in the manner of a telescope, and provision must be made in the interior of the temple for a stretching mechanism. A use of the device for existing eyeglass frames is not possible.

It is one object of the invention to create a device for tautening the facial skin and the cheekbone musculature (zygomaticus major and zygomaticus minor) of the user, which has a simple in design and manufacture, and which is robust and durable at the same time, wherein an adjustment of the tautening pressure or of the tautening strength, respectively, is possible prior to and during the use of the device. Preferably, the tensioning device is visible as little as possible.

This and other objects is solved according to the invention in that the tensioning device comprises a tensioning bow and a spring element, which tensions the tensioning bow, wherein the tensioning bow is arranged on the side of the supporting part facing the head of the user, and the spring element is engaged at one end with the supporting part and at the other end with the tensioning bow.

When putting on such a device, the tensioning device is initially operated manually (the tensioning bows are pulled downwards by means of a rotation) and the multipurpose device is then applied. The facial skin and the cheekbone musculature are seized by the spring element and are entrained upwards as well as backwards, whereby the desired tautening effect is attained. The facial skin and/or the cheekbone musculature is held under elastic tension through this.

In this case, the tensioning bow itself serves as operating element of the tensioning device. An independent operating element is thus not required.

According to the invention, the spring element can be embodied as spiral spring or as torsion compression spring. The spring element can be arranged on the side of the supporting part facing the head of the user, so as to prevent that the tensioning device is visible from the outside. The advantage of using a torsion (rotary) compression spring according to the invention is that a compressive force as well as a tractive force is exerted on the face of the user in response to the use.

The spring element can also be arranged on the side of the supporting part facing away from the head of the user, wherein provision is preferably made in this case for an operating element, which covers the spring element and which is engaged with the tensioning bow, in particular in the form of a rotary handle.

The torsion compression spring according to the invention can comprise a fastening plate located on the inside, a frame, as well as preferably three arms, which connect the fastening plate to the frame. Preferably, the arms are embodied so as to be elastic and hold the fastening part at a predefined distance vertically to the plane of the frame. It is ensured through this that by exerting a pressure on the fastening plate, the latter performs a rotatory movement and is placed under elastic tension. Provision is also made for embodiments comprising more than three arms. The arms are bent across a certain angular range, which determines the angular range of the rotatory movement of the fastening plate.

At the fastening plate, the torsion compression spring can be connected to the supporting part of the multipurpose device, and, at its frame, it can be connected to the tensioning bow. For operating the tensioning device, the user only needs to press the tensioning bow against the supporting part by hand. The tensioning bow thus performs a rotatory movement on its own and is placed under elastic tension. In use, the tensioning bow exerts pressure as well as tractive forces on the face of the user by means of the torsion compression spring according to the invention.

During the use, the tension of the tensioning bow can be adjusted at any time. It is particularly advantageous, if the torsion compression spring is embodied in one piece with the tensioning bow, for example punched out from a metal or plastic. Tensioning bow and torsion compression spring can also be made of a plurality of parts. In particular, the tensioning bow can comprise a wire, a plastic or a metal. The torsion compression spring can also comprise a wire, a plastic or a metal, in particular a spring steel. The tensioning bow can encompass a U-shaped deflection, which serves as reinforcement. The torsion compression spring and the tensioning bow can also be soldered together or can be connected to one another in a different way, either in a form-locking or force-locking manner.

The torsion compression spring can be screwed to, adhered to the supporting part, or can be clipped on so as to be capable of being detached, for example by means of a bow, which is provided specifically for this purpose. Provision can furthermore be made for a stop, preferably in the form of a pin, which engages with a corresponding recess of the tensioning bow, so as to limit the pivot movement thereof.

Provision can be made according to the invention for the tensioning device to be capable of being detachably fastened to the supporting part and in particular so as to be capable of being clipped on, adhered or screwed on. This allows for a simple retrofitting of existing eyeglass frames. According to the invention, provision can be made for the tensioning bow to encompass at least one preferably elastic clamping jaw, which can be attached to the facial skin in the area of the cheekbone. Provision can also be made at the tensioning bow for a plurality of clamping jaws, so as to intensify the effect of tension or pressure, respectively.

In order for the force connection between the clamping jaw and the skin located above the zygomatic bone being ensured, the eyeglass frame and the temples can be embodied in a correspondingly stiff manner. The eyeglass frame can furthermore be adapted to the shape of the face or to the width of the face, respectively.

The attaching of the clamping jaw to the tensioning bow can be made by means of a force-locking and/or form-locking connection, for example by means of adhesion, suction, pinching, hooking or shrinking on. In the attached state, the tensioning device can be arranged so as to be covered or so as not to be visible to the user, respectively.

The tensioning bow can be embodied in the form of an ear bow, which is attached or which can be attached in a pivotable manner to the supporting parts. This makes it possible for the required ear bow to additionally fulfill the function of the tensioning bow, so that additional components are not required. For this purpose, provision can be made for a hinge between the supporting part and the ear bow, wherein a torsion spring is arranged, which is connected at one end to the supporting part, in particular to the temple, and, at the other end, to the tensioning bow or to a rotary handle. The connection of the torsion spring can be embodied in a force-locking manner, in a form-locking manner or by means of a connecting means, such as glue. The hinge can encompass an operating element, in particular a rotary handle, for operating the tensioning device.

To fix the tensioning device in predetermined positions, provision can be made for a releasable clamping device. In that the clamping jaw or the clamping bow, respectively, of the tensioning device is adjustably fixable, the contact pressure on the face can be varied. The fixation of the tensioning bow in predetermined pivot positions can be made by means of catch mechanisms or snap-action connections. In particular, provision can be made to provide recesses at the supporting part and at the tensioning bow, wherein a snap-fit in any pivot position can take place by inserting a clamping pin.

The lateral supporting part, in particular temple, can be embodied as cover for the tensioning device. For tensioning the tensioning device, the supporting part can encompass an elastically stretchable or longitudinally adjustable section. The support can in particular consist of parts, which are supported so as to be capable of being displaced inside one another or against one another. The supporting part can be supported so as to be capable of being displaced along a sliding guide, wherein the sliding guide is embodied as the receiving part of a plug-connection. The supporting part can consist of two elements, which are pivotably connected to a hinge, wherein a torsion spring is arranged concentrically about the axis of the hinge, and one end of the torsion spring is connected to a clamping jaw, which can be applied to the facial skin, and the other end of the torsion spring is connected to an ear bow, wherein, for tensioning the tensioning device, the element of the supporting part, which is folded up, can be folded down together with the ear bow and can be applied behind the earlap.

The multipurpose device can in particular be embodied as eyeglass frame. An advantageous effect of the invention is attained in that the tensioning device as well as the adhesive pads are arranged behind the inner sides of lateral posts of an eyeglass frame. The tensioning device is thus covered, at least in the tensioned state, and not visible to an observer. Further features according to the invention follow from the claims, the description and the drawings.

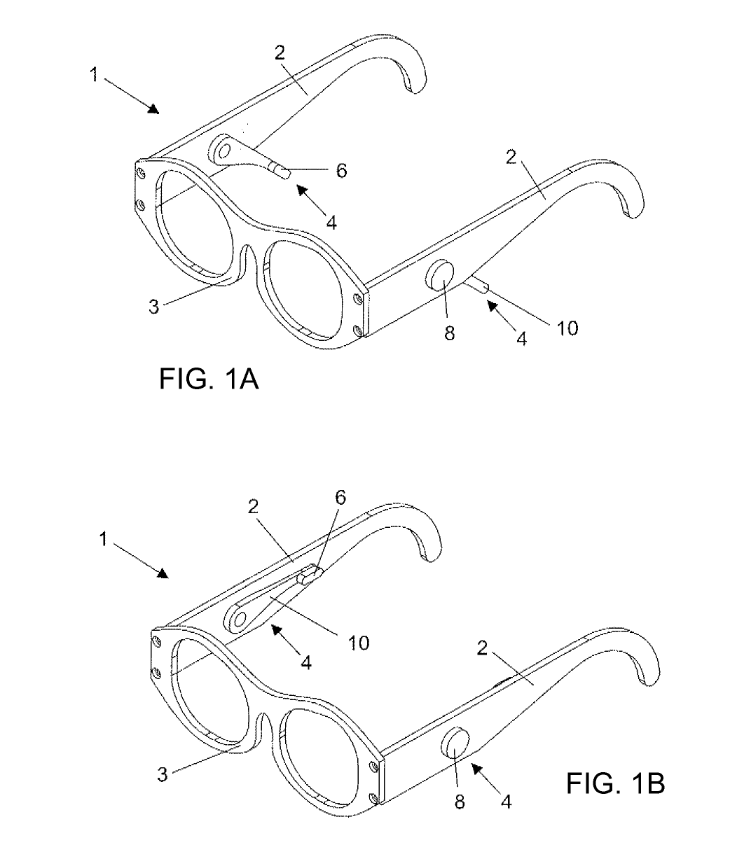

FIG. 1a shows an exemplary embodiment of the multipurpose device according to the invention as eyeglass frame in the open state;

FIG. 1b shows an exemplary embodiment of the multipurpose device according to the invention as eyeglass frame in the closed state;

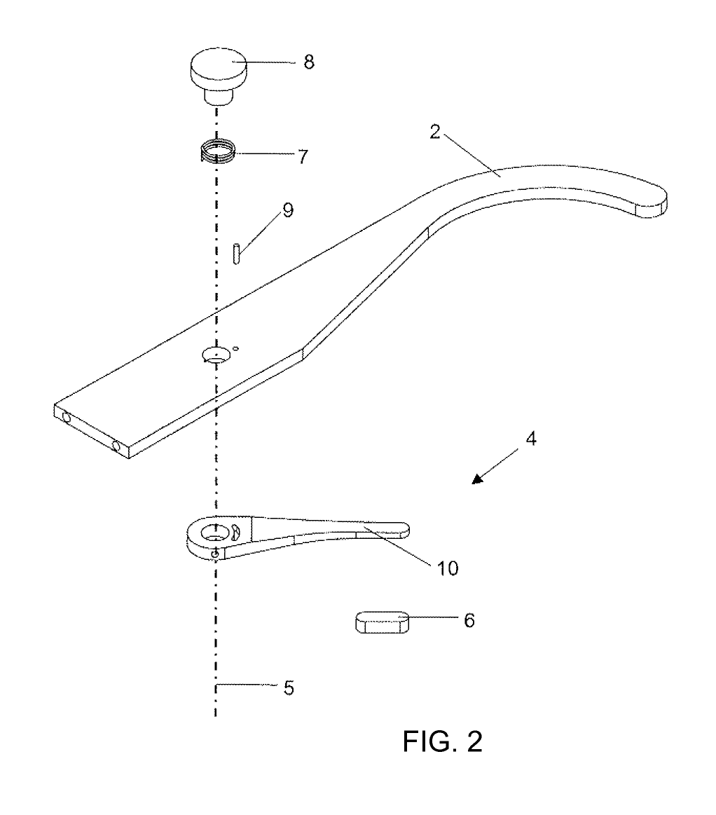

FIG. 2 shows the design of the tensioning device according to the invention and the fastening thereof to the supporting part of the eyeglass frame;

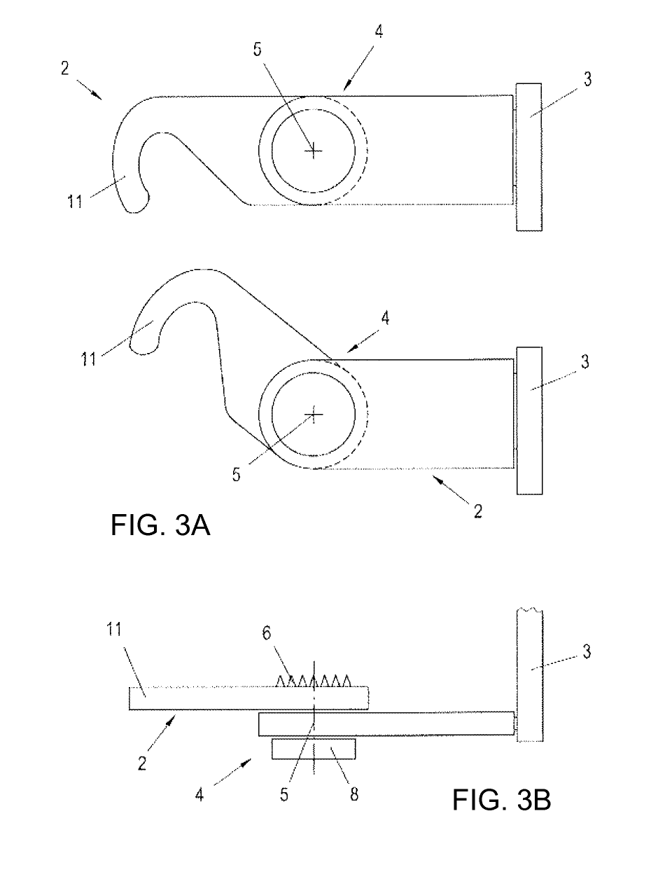

FIGS. 3a and 3b show a further exemplary embodiment of the multipurpose device according to the invention as eyeglass frame;

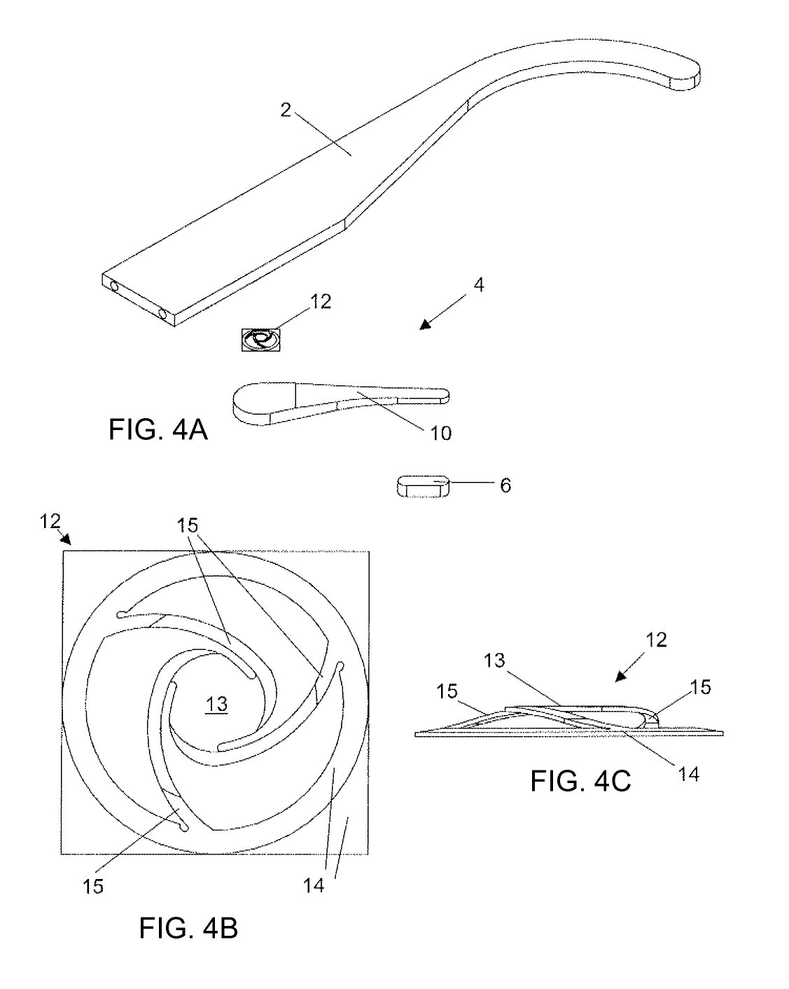

FIGS. 4a-4c show a further exemplary embodiment of the multipurpose device according to the invention using a torsion (rotary) compression spring;

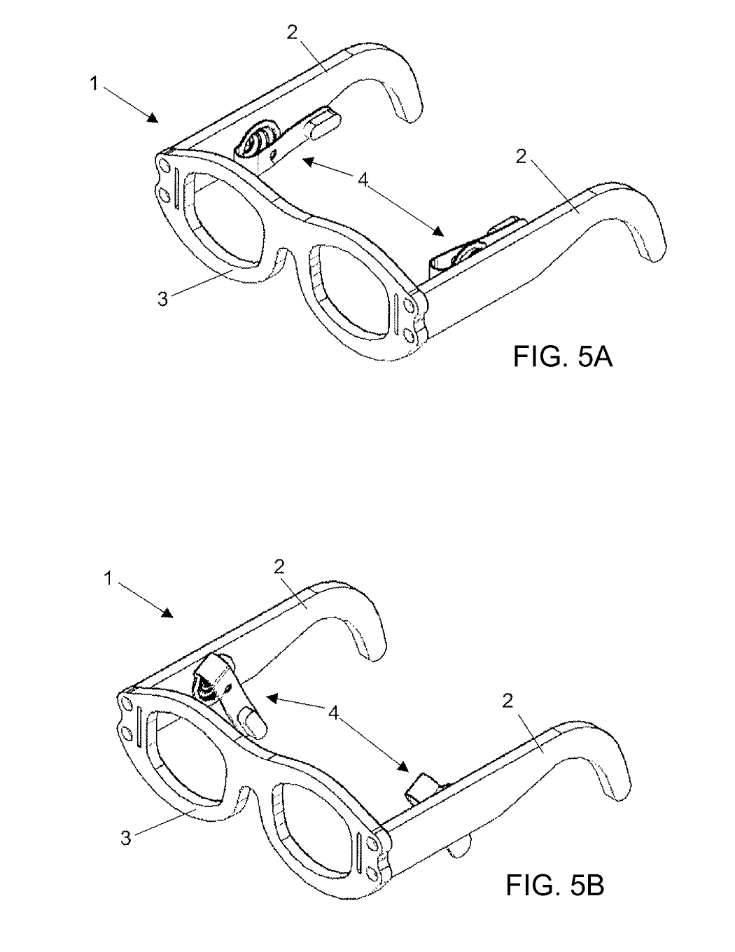

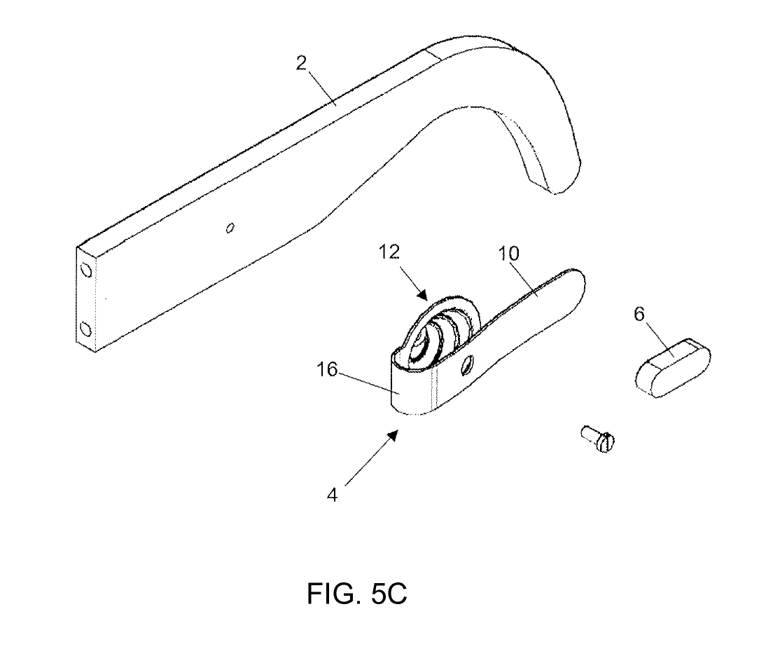

FIGS. 5a-5c show a further exemplary embodiment of the multipurpose device according to the invention using a torsion compression spring;

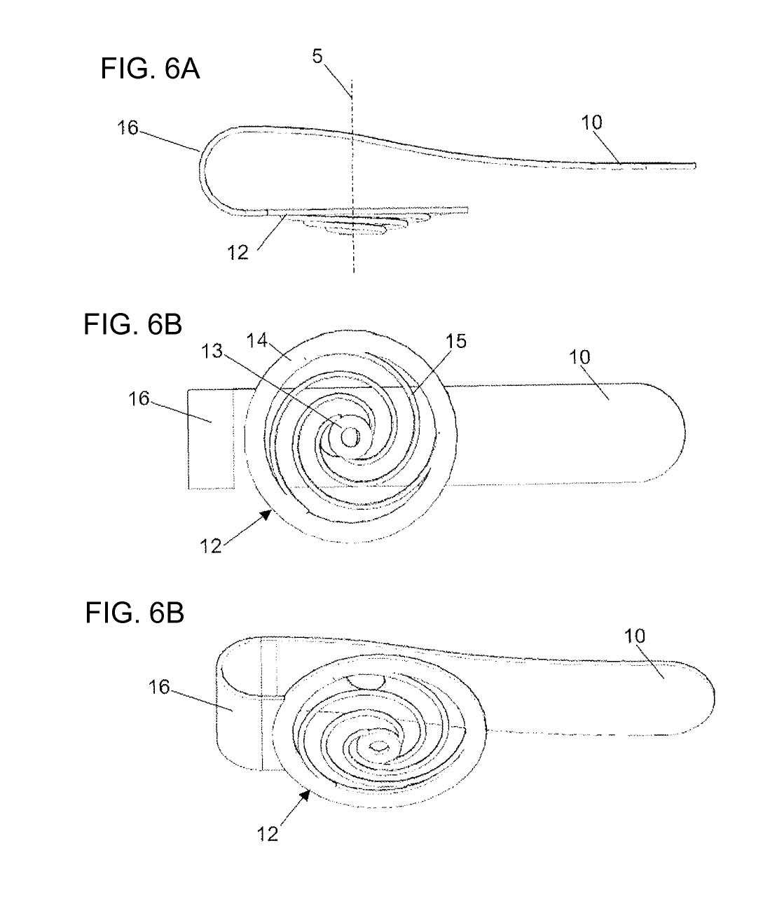

FIGS. 6a-6c show views of a torsion compression spring according to the invention;

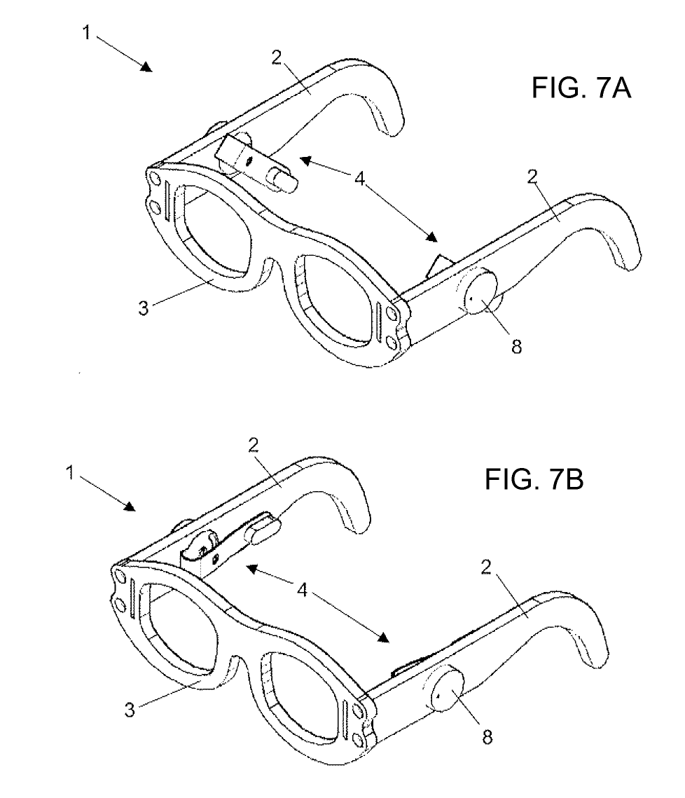

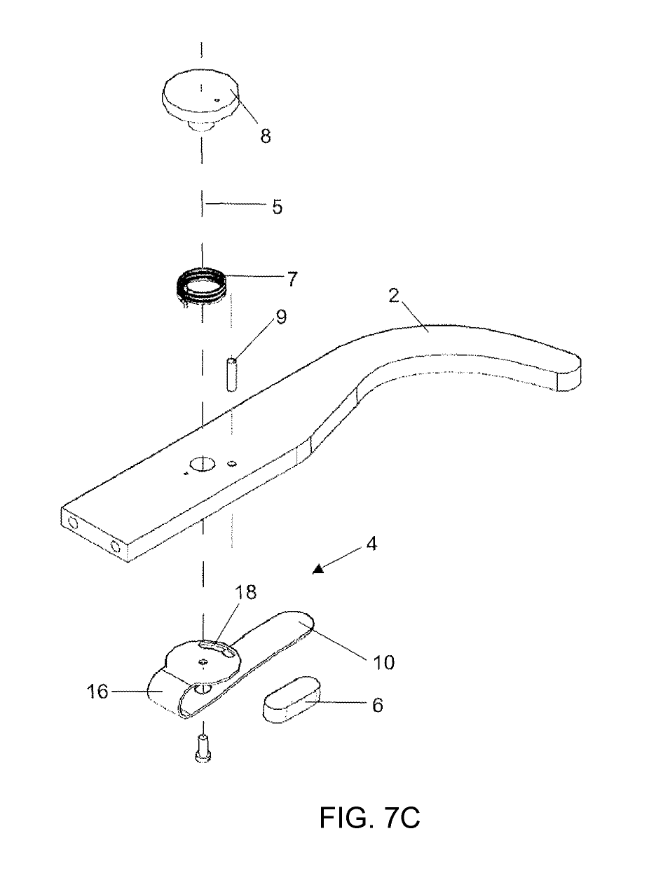

FIGS. 7a-7c show a further exemplary embodiment of the multipurpose device according to the invention using a spiral torsion spring;

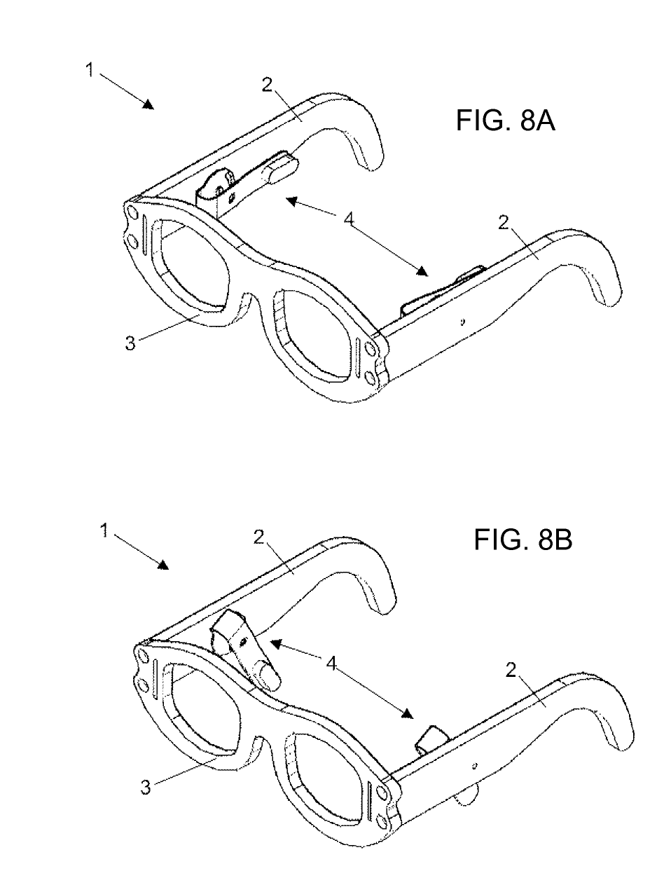

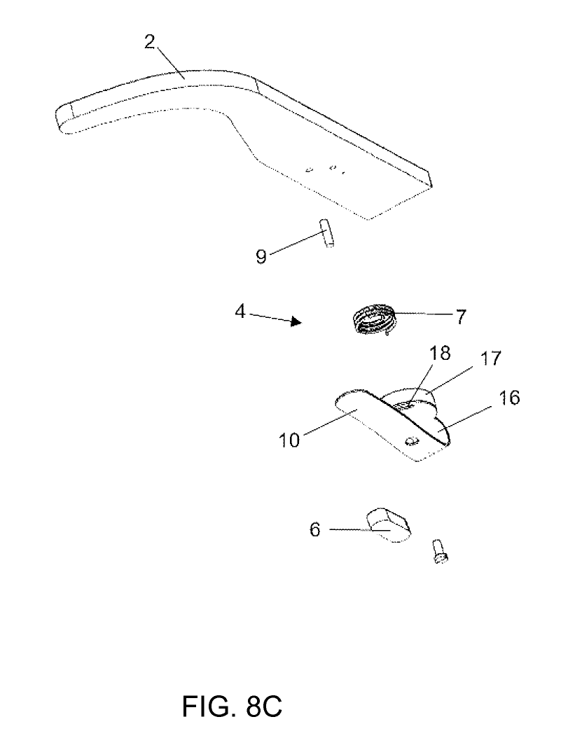

FIGS. 8a-8c show a further exemplary embodiment of the multipurpose device according to the invention using a spiral torsion spring.

FIG. 1a shows the multipurpose device 1 in the form of an eyeglass frame comprising supporting parts 2 and a vision aid 3. A tensioning device 4 is in each case attached to the two supporting parts 2. The tensioning device 4 is rotatably connected to the supporting parts 2. In this figure, the tensioning device 4 is not operated, the tensioning bows 10 are pushed downwards by the user. Clamping jaws 6, which, in the operated state, pull the facial skin upwards by means of the force of a torsion spring, are attached to the tensioning bows 10 of the tensioning device 4. The tensioning bows 10 can be tightened by operating the rotary handles 8.

FIG. 1b shows the exemplary embodiment of FIG. 1a in the operated state: the tensioning bows 10 of the tensioning device 4 push upwards and pull the facial skin backwards accordingly, so as to attain the desired effect.

FIG. 2 shows the design of the tensioning device 4 and the fastening thereof to the supporting part 2 of the eyeglass frame. For this purpose, the supporting part 2 encompasses a recess, into which the rotary handle 8 can be inserted. At one end, the torsion spring 7 is connected to the rotary handle, and, at the other end, it is connected to the supporting part. The rotary handle 8 encompasses a pin, which is connected to the tensioning bow 10. The torsion spring thus acts directly on the tensioning bow 10 and presses the latter upwards. The position of the tensioning bow 10 is determined by means of the stop 9 in the form of a fixing pin. The clamping jaw 6 is attached at one end of the tensioning bow 10. Optionally, a further clamping jaw 6 can be attached at the tensioning bow 10 in the area of the axis of rotation 5.

FIGS. 3a and 3b show further exemplary embodiments of the multipurpose device according to the invention. The multipurpose device 1 is embodied in the form of an eyeglass frame comprising supporting parts 2 and a vision aid 3. A tensioning device 4 is attached to the supporting part 2.

The tensioning device 4 is rotatably connected to the supporting part 2 along the axis of rotation 5. In this exemplary embodiment, the tensioning bow is embodied in the form of a pivotably supported ear bow 11, which is attached or can be attached to the supporting parts 2 in a pivotable manner. A (non-illustrated) torsion spring, which tightens the ear bow 11 downwards against a stop, is arranged in the interior of the arrangement. When putting on the eyeglasses, the ear bow 11 is folded upwards against the spring force, as is shown in the bottom illustration of FIG. 3a.

The clamping jaws 6, which are attached to the ear bow 11 in the area of the hinge 5, are applied to the skin in the area of the cheekbone musculature by the user, and the clamping jaws 6 clamp the facial musculature in the desired direction when letting go of the ear bows 11. The ear bows 11 also serve to hold the eyeglasses in the usual way. A cross section through this embodiment of the invention is shown in FIG. 3b, wherein the rotary handle 8 and the clamping jaw 6 are also visible. The ear bow 11 can be tightened by operating the rotary handle 8.

FIG. 4a to FIG. 4c show an embodiment of the support clamp of a multipurpose device according to the invention. A torsion compression spring 12 is provided as spring element. The torsion compression spring 12 comprises a frame 14, which is located on the outside, and a fastening plate 13, which is connected to the frame 14 via three flexible arms 15. The torsion compression spring 12 is made of an elastic spring steel, for example punched out. The fastening plate 13 is fastened to the supporting part 2, for example glued or screwed.

The rotary motion of the freely movable frame 14 is effected by pressure. It is thus only necessary to exert pressure on the frame 14, a rotary motion as in the case of a spiral spring is not necessary. The frame 14 it attached to the tensioning bow 10, for example soldered, or is embodied in one piece therewith.

The fastening plate 13 can be fastened to the supporting part 2 in a force-locking manner by means of a central screw or by means of stabilizing the position by means of a plurality of screws, or in a form-locking manner, by means of a square bore or the like. The frame 14 can also be fastened to the tensioning bow 10 in a corresponding manner.

FIGS. 5a-5c show a further exemplary embodiment of the multipurpose device according to the invention using a torsion compression spring. In this exemplary embodiment, the tensioning bow 10 is embodied in one piece with the spring element in the form of the torsion compression spring 12. The torsion compression spring 12 is attached on the sides of the supporting parts 2 facing the head of the user by means of a screw connection. The tensioning bow 10 extends from the outer circumference of the frame of the torsion compression spring via a deflection 16 in the direction of the back of the user's head and supports the clamping jaw 6. The deflection 16 increases the torsional stiffness of the spring steel and ensures a particularly good transfer of the rotational force.

FIGS. 6a-6c show views of a torsion compression spring 12 according to the invention. Said torsion compression spring is made of spring steel and is embodied in one piece with the tensioning bow 10. The torsion compression spring 12 encompasses a central fastening plate 13 and a frame 14, wherein the tensioning bow 10 is integrally molded to the frame 14.

Three elastic arms 15, which are bent spirally, extend between the fastening plate 13 and the frame 14, wherein the fastening plate 13 is arranged so as to be spaced apart from the plane of the frame 14 in the direction of axis of rotation 5 of the torsion compression spring. As a result, it is attained that the frame 14 performs a rotatory movement when the frame 14 is pressed against the fastening plate 13, wherein the angular range of this movement as well as the exerted tractive and compressive force is determined by the length, shape and elasticity of the arms 15.

The tensioning bow 10 is not connected to the frame 14 of the torsion compression spring 12 in a plane, but in a spaced-apart position, which is attained in that the tensioning bow 10, starting at the frame 14, encompasses an approximately U-shaped deflection 16. This has a plurality of advantages. Initially, the torsional stiffness of the design is increased through this. Such a design furthermore allows for adapting the position of the tensioning bow and of the clamping jaw fastened thereto to the user.

FIGS. 7a-7c show a further exemplary embodiment of the multipurpose device according to the invention using a spiral torsion spring. In this exemplary embodiment, the spiral torsion spring 7 is arranged on the side of the supporting part 2, which faces away from the head of the user. A rotary handle 8 covers the spiral torsion spring 7, so that the latter is not visible from outside. The spiral torsion spring 7 is engaged at one end with the rotary handle 8, and at the other end with the supporting part 2, wherein the rotary handle 8 is connected to the tensioning bow 10. The tensioning bow 10 is formed similarly as in the exemplary embodiment of FIGS. 5a-5c, but does not encompass a torsion compression spring. However, it also encompasses a deflection 16. Provision is furthermore made in the tensioning bow 10 for a clearance 18, which interacts with a stop 9 in the form of a pin, so as to define the rotary motion of the tensioning bow 10.

FIGS. 8a-8c show a further exemplary embodiment of the multipurpose device according to the invention using a spiral torsion spring. In this exemplary embodiment, the spiral torsion spring 7 is arranged on the side of the supporting part 2, which faces the head of the user, so that it is not visible from outside. The spiral torsion spring 7 is engaged at one end with the tensioning bow 10, and at the other end with the supporting part 2. The tensioning bow 10 is formed similarly as in the exemplary embodiment of FIGS. 5a-5c, but does not encompass a torsion compression spring.

The tensioning bow 10 also encompasses a deflection 16. To cover the spiral torsion spring 7, the tensioning bow 10 is provided with a cylindrical sleeve 17. Provision is furthermore made in the tensioning bow 10 for a clearance 18, which interacts with a stop 9 in the form of a pin, so as to define the rotary motion of the tensioning bow 10.

The invention is not limited to the exemplary embodiments. It is intended to market exemplary embodiments of the invention under the name “Zeilinger Liftingbrille”.

### LIST OF REFERENCE NUMERALS

1 multipurpose device
2 supporting part
3 vision aid
4 tensioning device
5 axis of rotation
6 clamping jaws
7 spiral torsion spring
8 rotary handle
9 stop
10 tensioning bow
11 ear bow
12 torsion compression spring
13 fastening plate
14 frame
15 arm
16 deflection
17 sleeve
18 clearance

1-15. (canceled)

16. A multipurpose device, comprising:
at least one supporting part to be applied to the head of a user and having a side facing the head of the user; and
a tensioning device being connected to or configured to be connected to said at least one supporting part and being pivotable about an axis of rotation for tautening the facial skin of the user;
said tensioning device including a tensioning bow and a spring element tensioning said tensioning bow;
said tensioning bow being disposed on said side of said at least one supporting part facing the head of the user; and
said spring element having one end engaged with said at least one supporting part and another end engaged with said tensioning bow.

17. The multipurpose device according to claim 16, wherein said at least one supporting part includes at least one of a vision aid or a hearing aid.

18. The multipurpose device according to claim 16, wherein said spring element is a spiral torsion spring.

19. The multipurpose device according to claim 16, wherein said spring element is a torsion compression spring.

20. The multipurpose device according to claim 16, wherein said spring element is disposed on said side of said at least one supporting part facing the head of the user.

21. The multipurpose device according to claim 16, wherein:
said at least one supporting part has a side facing away from the user;
said spring element is disposed on said side of said at least one supporting part facing away from the user; and
an operating control covers said spring element and is engaged with said tensioning bow.

22. The multipurpose device according to claim 21, wherein said operating control is a rotary handle.

23. The multipurpose device according to claim 19, wherein said torsion compression spring includes an inner fastening plate, a frame, and at least one arm connecting said fastening plate to said frame.

24. The multipurpose device according to claim 23, wherein said at least one arm is three arms.

25. The multipurpose device according to claim 23, wherein said torsion compression spring is connected to said at least one supporting part by said fastening plate, and said torsion compression spring is connected to said tensioning bow by said frame.

26. The multipurpose device according to claim 19, wherein said torsion compression spring is constructed in one piece with said tensioning bow.

27. The multipurpose device according to claim 16, wherein said tensioning bow includes a wire, plastic or a metal, and said torsion compression spring includes a wire, a metal, a spring steel or plastic.

28. The multipurpose device according to claim 16, wherein said tensioning bow includes a wire, plastic or a metal, or said torsion compression spring includes a wire, a metal, a spring steel or plastic.

29. The multipurpose device according to claim 16, wherein said tensioning bow has a U-shaped deflection serving as a reinforcement.

30. The multipurpose device according to claim 16, which further comprises a stop engaged with a corresponding recess formed in said tensioning bow to limit a pivot movement of said tensioning bow.

31. The multipurpose device according to claim 30, wherein said stop is a pin.

32. The multipurpose device according to claim 16, wherein said tensioning device is configured to be detachably fastened to said at least one supporting part.

33. The multipurpose device according to claim 32, wherein said tensioning device is configured to be screwed on or clipped on said at least one supporting part by a bow.

34. The multipurpose device according to claim 16, wherein said tensioning bow has at least one clamping jaw.

35. The multipurpose device according to claim 16, wherein said tensioning bow is an ear bow being pivotably attached or configured to be pivotably attached to said at least one supporting part.

36. The multipurpose device according to claim 16, wherein the multipurpose device is an eyeglass frame.
